(19) United States
(12) Patent Application Publication
(10) Pub. No.: US 2026/0070070 A1
(43) Pub. Date: Mar. 12, 2026

(54) HYPERGRAVITY CENTRIFUGE DEVICE AND TEMPERATURE CONTROL METHOD THEREFOR

(71) Applicants: ZHEJIANG UNIVERSITY, Hangzhou (CN); The Architectural Design & Research Institute of Zhejiang University Co., Ltd., Hangzhou (CN)

(72) Inventors: Yi Yang, Hangzhou (CN); Yinan Guo, Hangzhou (CN); De Ding, Hangzhou (CN); Jianqun Jiang, Hangzhou (CN); Weian Lin, Hangzhou (CN); Junxiang Yu, Hangzhou (CN); Shuai Yu, Hangzhou (CN); Yu Zhao, Hangzhou (CN)

(21) Appl. No.: 19/382,283

(22) Filed: Nov. 7, 2025

(30) Foreign Application Priority Data
Sep. 9, 2024 (CN) 202411252736.8

(51) Int. Cl. B04B 5/10; B04B 13/00; B04B 15/02; B04B 15/08

(52) U.S. Cl. CPC B04B 5/10; B04B 13/00; B04B 15/02; B04B 15/08

(57) ABSTRACT

The present disclosure relates to a hypergravity centrifuge device and a temperature control method therefor. The temperature control method for a hypergravity centrifuge device based on steady-state temperature prediction of the present disclosure includes: step S100, providing a hypergravity centrifuge device; step S200, carrying out temperature sampling at designated detection points in the working chamber, and obtaining corresponding temperature sampling vector; step S200, carrying out temperature sampling at designated detection points in the working chamber, and obtaining corresponding temperature sampling vector; step S400, comparing the predicted steady-state temperature with a control temperature and changing a temperature of a cooling medium in the cooling system accordingly; step S500, cycling steps S200-S400 according to a predetermined cycle to make the predicted steady-state temperature tend towards the control temperature.

### CROSS-REFERENCE TO RELATED APPLICATIONS

The present disclosure claims priority of Chinese Patent Application No. 202411252736.8, filed on Sep. 9, 2024, the entire contents of which are hereby incorporated by reference.

### TECHNICAL FIELD

The present disclosure relates to the technical field of model prediction, and in particular to a hypergravity centrifuge device and a temperature control method therefor.

### BACKGROUND

A hypergravity centrifuge device simulates a hypergravity environment by generating centrifugal force through high-speed rotation. As a rotation speed increases, frictional heat increases and a temperature rises rapidly. When the temperature inside the hypergravity centrifuge device exceeds 45° C., a lubricating oil may age and fail, and various experimental sensors may also have significant deviations. Therefore, the hypergravity centrifuge device needs to control the temperature not to exceed 45° C. Commonly used cooling methods for existing hypergravity centrifuge devices include side wall liquid cooling and vacuum pumping. It often takes several hours or even longer for the temperature of the hypergravity centrifuge device to stabilize. Temperature control, such as reducing the inlet water temperature of the cooling wall and vacuum pumping, is carried out after the temperature stabilizes or through simple linear control. This may result in temperature rise exceeding the limit or temperature rise being too low. Excessive temperature rise can lead to lubrication system failure and sensor errors, while insufficient temperature rise can significantly increase the energy consumption of a cooling system.

### SUMMARY

Based on this, it is necessary to provide a method for predicting a steady-state temperature of a hypergravity centrifuge device to address the aforementioned technical issues.

A temperature control method for a hypergravity centrifuge device based on steady-state temperature prediction of the present disclosure, including:
step S100, providing a hypergravity centrifuge device which is installed in a working chamber that can provide a vacuum environment and has a peripheral wall arranged around a rotational axis of the hypergravity centrifuge device and a cooling system acting at least on the peripheral wall;
step S200, carrying out temperature sampling at designated detection points in the working chamber, and obtaining corresponding temperature sampling vector [T(t1), T(t2), . . . , T(tm)]^{T}, where:
m is sampling times,
tm is time corresponding to the mth sampling,
T(tm) is a temperature obtained from the mth sampling;
step S300, obtaining a predicted steady-state temperature based on the temperature sampling vector, wherein the predicted steady-state temperature is T(t)=A₀+[A1, A2, . . . , An][e^{-b1*t}, e^{-b2*t}, . . . , e^{-bn*t}]^{T}, where:
A₀ is an initial temperature,
n is a number of specified detection points,
b1-bn are thermal eigenvalues of a thermal impedance matrix, the thermal impedance matrix is obtained based on the temperature sampling vector,
[A1, A2, . . . , An] is an eigenvector matrix of the thermal impedance matrix,
t is time;
step S400, comparing the predicted steady-state temperature with a control temperature and changing a temperature of a cooling medium in the cooling system accordingly;
step S500, cycling steps S200-S400 according to a predetermined cycle to make the predicted steady-state temperature tend towards the control temperature.

The following also provide several optional methods, but they do not serve as additional limitations on the overall solution mentioned above. They are only further supplements or optimizations. Without technical or logical contradictions, each optional method can be combined separately for the overall solution mentioned above, or it can be a combination between multiple optional methods.

Optionally, the hypergravity centrifuge device has an experimental chamber that rotates around a rotational axis, and the designated detection points are distributed on an inner side of the peripheral wall, with a height corresponding to the experimental chamber.

Optionally, there are multiple groups of designated detection points arranged along a height direction, and the designated detection points in the same group are arranged at intervals along a circumferential direction.

Optionally, in the step S400, first calculating ΔT=Tw−Tk, where Tk is the control temperature and Tw is the predicted steady-state temperature;
adjusting the temperature of the cooling medium to Tin−ΔT, where Tin is the current temperature of the cooling medium.

Optionally, the step S400 also comprises adjusting a vacuum degree inside the working chamber.

Optionally, in the step S400, before adjusting the vacuum degree, first determining whether a current temperature of the cooling medium is a lowest operating temperature;
when the predicted steady-state temperature is higher than the control temperature and the current temperature of the cooling medium is the lowest operating temperature, further increasing the vacuum degree inside the working chamber.

Optionally, the thermal impedance matrix is calculated as [H]n×n using the following formula:
[Z1]=[H]n×n[Z], wherein [Z] and [Z1] are two temperature sampling sequences, and [Z] and [Z1] are respectively:

$$[ Z ] = [ T ( t 1 ) - T ( t 1 + τ ) , T ( t 2 ) - T ( t 2 + τ ) , ⋯ , T ( tm ) - T ( tm + τ ) ] n \times m ,$$

$$[ Z 1 ] = [ T ( t 1 + τ ) - T ( t 1 + 2 τ ) , T ( t 2 + τ ) - T ( t 2 + 2 τ ) , ⋯ , T ( tm + τ ) - T ( t m + 2 τ ) ] n \times m ,$$

τ is a delay time, τ=kΔt, k is a positive integer. For example, k=1-10.

Optionally, the thermal impedance matrix is [H]n×n, and has an eigenvalue matrix:

$$[ \begin{matrix}{e}^{- b 1 * τ} & 0 ⋯ & 0 \\ ⋮ & {e}^{- b 2 * τ} ⋱ & ⋮ \\ 0 & ⋯ & {e}^{- bn * τ}\end{matrix} ] ;$$

and based on the eigenvalue matrix, the b1-bn are further obtained.

The present disclosure also provides a hypergravity centrifuge device based on steady-state temperature prediction, comprising:
a working chamber which is provided with a cooling system that acts on a peripheral wall of the working chamber, and a vacuum system that acts on an interior of the working chamber;
a hypergravity centrifuge device which is installed in the working room and has an experimental chamber that rotates around a rotational axis;
a sensor component located within the working chamber and arranged around the hypergravity centrifuge device;
a control system which receives detection signals from the sensor component and controls the cooling system and the vacuum system accordingly according to the temperature control method for a hypergravity centrifuge device according to the present disclosure.

Optionally, a height of the sensor component corresponds to a height of the experimental chamber;
the number of sensors in the sensor component is n and divided into multiple groups along a height direction, with sensors in the same group evenly spaced along a circumferential direction.

The temperature control method for the hypergravity centrifuge device in the present disclosure adopts a model prediction approach, which can quickly reach the expected control temperature in a short period of time, significantly reducing system energy consumption during this process.

### BRIEF DESCRIPTION OF DRAWINGS

FIG. 1 is a schematic diagram of a hypergravity centrifuge device in an embodiment of the present disclosure;

FIG. 2 is a schematic flowchart of a temperature control method for a hypergravity centrifuge device in an embodiment of the present disclosure;

FIG. 3 is a schematic diagram comparing predicted temperatures obtained using the temperature control method for a hypergravity centrifuge device of the present disclosure with CFD simulated temperatures.

### LIST OF REFERENCE SIGNS

100. working chamber; 200. cooling system; 210. compressor; 220. condenser, 230. expander; 240. evaporator; 300. vacuum pump; 400. hypergravity centrifuge device; 410. driving motor; 420. experimental chamber; 500. sensor component.

### DESCRIPTION OF EMBODIMENTS

In order to make the purpose, technical solution, and advantages of the present disclosure clearer and more understandable, the following will provide further detailed explanations of the present disclosure in conjunction with the accompanying drawings and embodiments. It should be understood that the specific embodiments described herein are only used to explain the present disclosure and are not intended to limit the present disclosure.

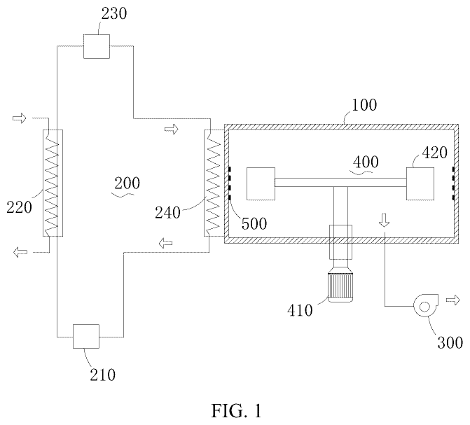

Referring to FIG. 1, in one embodiment of the present disclosure, a hypergravity centrifuge device based on steady-state temperature prediction is provided, including a working chamber 100 which has a peripheral wall and a corresponding top wall and a bottom wall. In order to control the temperature, a cooling system 200 is also configured. As for the cooling system 200 itself, existing technology can be used, for example, according to a direction of cooling medium delivery, the cooling system 200 includes a compressor 210, a condenser 220 (heat exchanger), an expander 230 or throttling device, and an evaporator 240 (heat exchanger) in sequence. The cooling medium has the lowest operating temperature according to performance parameters of the cooling system. For example, the heat exchanger of the cooling system 200 can be installed outside the peripheral wall or inside the peripheral wall interlayer of the working room 100.

In addition, a vacuum system is also configured, including a vacuum pump 300 and a vacuum pipeline connected between the vacuum pump 300 and the working chamber, for adjusting a vacuum degree inside the working chamber.

The hypergravity centrifuge device 400 is installed in the working room, and a bottom of a rotating shaft of the hypergravity centrifuge device 400 extends out of the working room 100 and is equipped with a driving motor 410. An experimental chamber 420 that rotates around a rotational axis is provided at a top of the rotating shaft.

In order to perform temperature sampling, a sensor component 500 is installed in the working chamber. For example, the number of sensors in the sensor component 500 is n, and it is divided into multiple groups along a height direction. Overall, a height of the sensor component 500 corresponds to a height of the experimental chamber. Due to the higher linear velocity of the experimental chamber during operation and the most severe heat generated by friction with the air inside the working chamber, placing the sensor component 500 on the outer side of the motion path of the experimental chamber is more conducive to predicting and controlling temperature. The same group of sensors are arranged around the hypergravity centrifuge device and evenly spaced along the circumferential direction. The sensors can be fixed on the inner side of the peripheral wall of the working chamber. At different positions in the circumferential direction, motion paths of the peripheral wall and the experimental chamber have the same radial distance. Similarly, at different positions in the circumferential direction, motion paths of each sensor and the experimental chamber have the same radial distance.

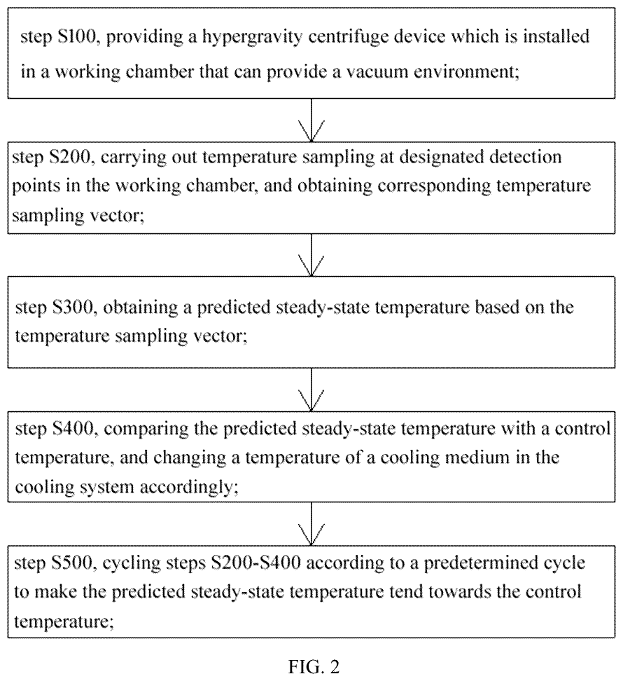

Referring to FIG. 2, based on the aforementioned hypergravity centrifuge device, an embodiment of the present disclosure provides a temperature control method for a hypergravity centrifuge device based on steady-state temperature prediction, including:

Step S100, providing a hypergravity centrifuge device, such as the hypergravity centrifuge device described in the previous embodiment, which is installed in a working chamber that can provide a vacuum environment. The working chamber has a peripheral wall arranged around a rotational axis of the hypergravity centrifuge device and a cooling system acting at least on the peripheral wall;

Step S200, carrying out temperature sampling at designated detection points in the working chamber. The designated detection points correspond to distribution positions of the sensors, which are generally distributed on an inner side of the peripheral wall and have a height corresponding to the experimental chamber. There are multiple groups of designated detection points arranged along a height direction, and the designated detection points in the same group are arranged at intervals along the circumferential direction.

After temperature sampling, the corresponding temperature sampling vector [T(t1), T(t2), . . . , T(tm)]^{T} can be obtained, where:
m is sampling times,
tm is time corresponding to the mth sampling,
T(tm) is a temperature obtained from the mth sampling;
Step S300, obtaining a predicted steady-state temperature based on the temperature sampling vector, wherein the predicted steady-state temperature is:

$$T ( t ) = {A}_{0} + {[ A 1 , A 2 , … , An ] [ {e}^{- b 1 * t} , {e}^{- {b}_{2} * t} , … , {e}^{- bn * t} ]}^{T} \qquad ( 2 )$$

Where:
A₀ is an initial temperature,
n is a number of specified detection points,
b1-bn are thermal eigenvalues of a thermal impedance matrix, which is obtained based on the temperature sampling vector,
[A1, A2, . . . , An] is an eigenvector matrix of the thermal impedance matrix,
t is time;

In this step, according to data from n known measurement points within the tm time period, the temperature rise curve (Formula 2) can be obtained. If the time t is sufficiently large (e.g. 3-15 minutes), the predicted steady-state temperature can be obtained.

The temperature rise curve in the working chamber can be decomposed into an expression consisting of n terms e^{-bn*t}, as follows:

$$T ( t ) = A 0 + {\sum }_{r = 1}^{n} Ar * {e}^{- br * t} ; \qquad ( 1 )$$

After converting formula (1) into a matrix expression, formula (2) can be obtained.

The thermal impedance matrix is calculated as [H] n×n using the following formula:

$$[ Z 1 ] = [ H ] n \times n [ Z ] ; \qquad ( 7 )$$

Where, [Z] and [Z1] are two temperature sampling sequences, and [Z] and [Z1] are respectively:

$$[ Z ] = [ T ( t 1 ) - T ( t 1 + τ ) , T ( t 2 ) - T ( t 2 + τ ) , … , T ( t m ) - T ( tm + τ ) ] n \times m ; \qquad ( 3 )$$

$$[ Z 1 ] = [ T ( t 1 + τ ) - T ( t 1 + 2 τ ) , T ( t 2 + τ ) - T ( t 2 + 2 τ ) , … , T ( tm + τ ) - T ( tm + 2 τ ) ] n \times m ; \qquad ( 4 )$$

τ is a delay time, τ=kΔt, k is a positive integer. For example, k=1-10.

The calculation method for b1-bn can be analyzed as follows:

At the sampling interval Δt, the temperature values of n specified detection points at each time can be obtained, with a sampling frequency of m. The resulting temperature sampling matrix is [{T(t1)}, {T(t2)}, . . . , {T(tm)}], which is as follows:

$$\{ \begin{matrix}{T}_{0}^{1} & {T}_{Δ t}^{1} & {T}_{2 Δ t}^{1} & {T}_{3 Δ t}^{1} & {T}_{4 Δ t}^{1} & {T}_{5 Δ t}^{1} … {T}_{( m - 1 ) Δ t}^{1} \\ {T}_{0}^{2} & {T}_{Δ t}^{2} & {T}_{2 Δ t}^{2} & {T}_{3 Δ t}^{2} & {T}_{4 Δ t}^{2} & {T}_{5 Δ t}^{2} … {T}_{( m - 1 ) Δ t}^{2} \\ {T}_{0}^{3} & {T}_{Δ t}^{3} & {T}_{2 Δ t}^{3} & {T}_{3 Δ t}^{3} & {T}_{4 Δ t}^{3} & {T}_{5 Δ t}^{3} … {T}_{( m - 1 ) Δ t}^{3} \\ {T}_{0}^{4} & {T}_{Δ t}^{4} & {T}_{2 Δ t}^{4} & {T}_{3 Δ t}^{4} & {T}_{4 Δ t}^{4} & {T}_{5 Δ t}^{4} … {T}_{( m - 1 ) Δ t}^{4} \\ ⋮ & & & & & \\ {T}_{0}^{n} & {T}_{Δ t}^{n} & {T}_{2 Δ t}^{n} & {T}_{3 Δ t}^{n} & {T}_{4 Δ t}^{n} & {T}_{5 Δ t}^{n} … {T}_{( m - 1 ) Δ t}^{n}\end{matrix} \} ;$$

Based on this, two temperature sampling sequences [Z] and [Z1] can be constructed. Using [Z1]=[H]n×n [Z], the thermal impedance matrix [H]n×n can be obtained.

According to formula (1), formulas (5) and (6) can be obtained:

$$formula ( 5 )$$

$$T ( t ) - T ( t + τ ) = [ A 1 , A 2 , \text{} … , \text{} An ] [ \text{} \begin{matrix}1 - {e}^{- b 1 * τ} & 0 … & 0 \\ ⋮ & 1 - {e}^{- b 2 * τ} ⋱ & ⋮ \\ 0 & … & 1 - {e}^{- b n * τ}\end{matrix} ] [ \text{} \text{} {e}^{- b 1 * t} , {e}^{- b 2 * t} , {e}^{- b n * t} ] T ;$$

$$formula ( 6 )$$

$$T ( t + τ ) - T ( t + 2 τ ) = [ A 1 , A 2 , … , An ] [ \text{} \begin{matrix}{e}^{- b 1 * τ} & 0 … & 0 \\ ⋮ & {e}^{- b 2 * τ} ⋱ & ⋮ \\ 0 & … & {e}^{- b n * τ}\end{matrix} ] [ \text{} \begin{matrix}1 - {e}^{- b 1 * τ} & 0 … & 0 \\ ⋮ & 1 - {e}^{- b 2 * τ} ⋱ & ⋮ \\ 0 & … & 1 - {e}^{- b n * τ}\end{matrix} ] * [ \text{} \text{} {e}^{- b 1 * t} , {e}^{- b 2 * t} , {e}^{- b n * t} ] T ;$$

Substituting formulas (5) and (6) into formulas (3) and (4), combined with formula (7), obtains:

$${[ A 1 , A 2 , … , An ]}^{- 1} [ H ] n \times n [ A 1 , A 2 , … , An ] = [ \text{} \begin{matrix}{e}^{- b 1 * τ} & 0 … & 0 \\ ⋮ & {e}^{- b 2 * τ} ⋱ & ⋮ \\ 0 & … & {e}^{- b n * τ}\end{matrix} ] ; \qquad ( 8 )$$

It can be seen that the thermal impedance matrix is [H]n×n and has an eigenvalue matrix:

$$[ \text{} \begin{matrix}{e}^{- b 1 * τ} & 0 … & 0 \\ ⋮ & {e}^{- b 2 * τ} ⋱ & ⋮ \\ 0 & … & {e}^{- b n * τ}\end{matrix} ] ,$$

and the eigenvector matrix is [A1, A2, . . . , An]. By performing eigenvalue decomposition on matrix [H]n×n, the thermal eigenvalues br(r=1, 2, 3 . . . n) can be obtained, corresponding to b1-bn.

The calculation method for the eigenvector matrix [A1, A2, . . . , An] can be analyzed as follows:

For a specified detection point with a sampling times m, the temperature sampling vector of the specified detection point is:

$$[ T ] m \times 1 = {[ T ( t 1 ) , T ( t 2 ) , … , T ( tm ) ]}^{T} ; \qquad ( 9 )$$

Where T(tm) is a temperature obtained from the mth sampling. tm is time corresponding to the mth sampling. Substituting the expression for T(t) in formula (2) into formula (9) obtains formula (10)

$${[ T ]}_{mX 1} = {{P}_{mX ( n + 1 )} [ A 1 , A 2 , … , An ]}^{T} ; \qquad ( 10 )$$

$$where {P}_{mX ( n + 1 )} = [ \begin{matrix}1 & {e}^{- b 1 * t 1} … & {e}^{- bn * t 1} \\ ⋮ & ⋱ & ⋮ \\ 1 & {e}^{- b 1 * tm} … & {e}^{- b n * t m}\end{matrix} ] ; \qquad ( 11 )$$

Since the thermal characteristic value br has already been obtained and tm is also a known sampling time, P_{mX(n+1)} is a known value. According to formula (10), [A1, A2, . . . , An]^{T} can be obtained, and then [A1, A2, . . . , An] can be obtained.

Step S400: comparing the predicted steady-state temperature with the control temperature and adjust the temperature of the cooling medium in the cooling system accordingly.

For steady-state states, according to heat transfer theory, there is a simplified formula (12)

$$Q = A * h * ( Tw - Tin ) ; \qquad ( 12 )$$

where:
A is a heat exchange area;
h is a heat transfer coefficient;
Tk is a control temperature;
Tw is a predicted steady-state temperature;
Tin is a current temperature of the cooling medium.

When the predicted steady-state temperature Tw is ΔT higher than the control temperature Tk, according to formula (12), it is necessary to reduce the current temperature Tin of the cooling medium by ΔT in order to reduce the predicted steady-state temperature Tw and approach the control temperature Tk. Similar conclusions were obtained through CFD numerical simulation, that is, when the current temperature Tin of the cooling medium decreases by ΔT, the predicted steady-state temperature Tw will also decrease by about ΔT.

In the step, ΔT can be calculated according to formula (13).

$$Δ T = Tw - Tk ; \qquad ( 13 )$$

Adjust the temperature of the cooling medium to Tin−ΔT through the cooling system.

When the predicted steady-state temperature is higher than the control temperature and the current temperature of the cooling medium is the lowest operating temperature, it can be understood that it is difficult to change the predicted steady-state temperature by reducing the temperature of the cooling medium. At this time, vacuum degree adjustment (i.e. driving the vacuum system to further increase the vacuum degree inside the working chamber) can be combined to reduce heat generated by friction between an equipment and the air inside the working chamber, in order to change the predicted steady-state temperature.

A specific adjustment range of the vacuum degree can be obtained based on CFD numerical calculations or experiments to determine the relationship between vacuum degree and ΔT(Tw−Tk), and the vacuum degree can be adjusted according to ΔT.

Step S500, during the operation, performing real-time temperature sampling, and cycling steps S200-S400 according to a predetermined cycle to make the predicted steady-state temperature tend towards the control temperature.

After adjusting the temperature of the cooling medium and the vacuum degree, the temperature rise curve, i.e. the parameters in formula (2), also changes. Therefore, it is necessary to perform m samples in the next time period (usually 3-15 minutes for each time period) and obtain the predicted steady-state temperature Tw until ΔT approaches 0.

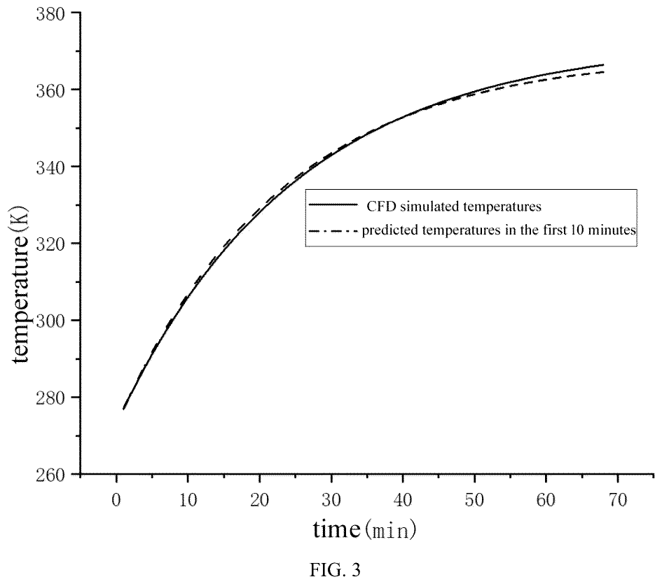

Referring to FIG. 3, through the temperature control method described in the above embodiment, and based on the high coincidence between the predicted temperatures in the first 10 minutes and the CFD simulated temperature, it indicates that the accuracy of the prediction is better. Compared to the CFD simulated temperature, the present disclosure is more convenient and efficient, and can control the temperature of the working room in real time.

The temperature control method for the hypergravity centrifuge device based on steady-state temperature prediction in the present disclosure can quickly predict a steady-state temperature by detection points temperature of the high-temperature zone in a short period of time, and adjust the chilled water temperature Tin according to the deviation value between the predicted steady-state temperature and the control temperature and control the vacuum degree (control frictional heat) to achieve the purpose of controlling the steady-state temperature.

The various technical features of the above embodiments can be combined arbitrarily. In order to make the description concise, not all possible combinations of the various technical features in the above embodiments have been described. However, as long as there is no contradiction in the combination of these technical features, they should be considered within the scope of this specification. When the technical features of different embodiments are reflected in the same figure, it can be regarded that the figure also discloses the combination examples of the various embodiments involved.

The above embodiments only express several embodiments of the present disclosure, and their descriptions are more specific and detailed, but should not be understood as limiting the scope of the invention patent. It should be pointed out that for ordinary technical personnel in the art, several modifications and improvements can be made without departing from the concept of the present disclosure, which are within the scope of protection of the present disclosure. Therefore, the scope of protection of the present disclosure should be based on the attached claims.

What is claimed is:

1. A temperature control method for a hypergravity centrifuge device based on steady-state temperature prediction, comprising:
step S100, providing a hypergravity centrifuge device which is installed in a working chamber that can provide a vacuum environment and has a peripheral wall arranged around a rotational axis of the hypergravity centrifuge device and a cooling system acting at least on the peripheral wall;
step S200, carrying out temperature sampling at designated detection points in the working chamber, and obtaining corresponding temperature sampling vector [T(t1), T(t2), . . . , T(tm)]^{T},
where:
m is sampling times,
tm is time corresponding to the mth sampling,
T(tm) is a temperature obtained from the mth sampling;
step S300, obtaining a predicted steady-state temperature based on the temperature sampling vector, wherein the predicted steady-state temperature is T(t)=A₀+[A1, A2, . . . , An][e^{-b1*t}, e^{-b2*t}, . . . , e^{-bn*t}]^{T}, where:
A₀ is an initial temperature,
n is a number of specified detection points,
b1-bn are thermal eigenvalues of a thermal impedance matrix, the thermal impedance matrix is obtained based on the temperature sampling vector, [A1, A2, . . . , An] is an eigenvector matrix of the thermal impedance matrix,
t is time;
step S400, comparing the predicted steady-state temperature with a control temperature, and changing a temperature of a cooling medium in the cooling system accordingly;
step S500, cycling steps S200-S400 according to a predetermined cycle to make the predicted steady-state temperature tend towards the control temperature;
wherein, in step S300, the thermal impedance matrix is calculated as [H]n×n using the following formula:
[Z]=[H]n×n[Z], wherein [Z] and [Z1] are two temperature sampling sequences, and [Z] and [Z1] are respectively:
$$[ Z ] = [ T ( t 1 ) - T ( t 1 + τ ) , T ( t 2 ) - T ( t 2 + τ ) , … , T ( tm ) - T ( tm + τ ) ] n \times m ,$$
$$[ Z 1 ] = [ T ( t 1 + τ ) - T ( t 1 + 2 τ ) , T ( t 2 + τ ) - T ( t 2 + 2 τ ) , … , T ( tm + τ ) - T ( tm + 2 τ ) ] n \times m ,$$
τ is a delay time, τ=kΔt, k is a positive integer;
the thermal impedance matrix has an eigenvalue matrix:
$$[ \text{} \begin{matrix}{e}^{- b 1 * τ} & 0 … & 0 \\ ⋮ & {e}^{- b 2 * τ} ⋱ & ⋮ \\ 0 & … & {e}^{- b n * τ}\end{matrix} ] ;$$
and based on the eigenvalue matrix, the b1-bn are further obtained.

2. The temperature control method for a hypergravity centrifuge device based on steady-state temperature prediction according to claim 1, wherein the hypergravity centrifuge device has an experimental chamber that rotates around a rotational axis, and the designated detection points are distributed on an inner side of the peripheral wall, with a height corresponding to the experimental chamber.

3. The temperature control method for a hypergravity centrifuge device based on steady-state temperature prediction according to claim 1, wherein there are multiple groups of designated detection points arranged along a height direction, and the designated detection points in the same group are arranged at intervals along a circumferential direction.

4. The temperature control method for a hypergravity centrifuge device based on steady-state temperature prediction according to claim 1, wherein in the step S400, first calculating ΔT=Tw−Tk, where Tk is the control temperature and Tw is the predicted steady-state temperature;
adjusting the temperature of the cooling medium to Tin−ΔT, where Tin is the current temperature of the cooling medium.

5. The temperature control method for a hypergravity centrifuge device based on steady-state temperature prediction according to claim 4, wherein the step S400 also comprises adjusting a vacuum degree inside the working chamber.

6. The temperature control method for a hypergravity centrifuge device based on steady-state temperature prediction according to claim 5, wherein in the step S400, before adjusting the vacuum degree, first determining whether a current temperature of the cooling medium is a lowest operating temperature;
when the predicted steady-state temperature is higher than the control temperature and the current temperature of the cooling medium is the lowest operating temperature, further increasing the vacuum degree inside the working chamber.

7. A hypergravity centrifuge device based on steady-state temperature prediction, comprising:
a working chamber which is provided with a cooling system that acts on a peripheral wall of the working chamber, and a vacuum system that acts on an interior of the working chamber;
a hypergravity centrifuge device which is installed in the working room and has an experimental chamber that rotates around a rotational axis;
a sensor component located within the working chamber and arranged around the hypergravity centrifuge device;
a control system which receives detection signals from the sensor component and controls the cooling system and the vacuum system accordingly according to the temperature control method for a hypergravity centrifuge device according to claim 1.

8. The hypergravity centrifuge device according to claim 7, wherein a height of the sensor component corresponds to a height of the experimental chamber;
the number of sensors in the sensor component is n and divided into multiple groups along a height direction, with sensors in the same group evenly spaced along a circumferential direction.

9. A hypergravity centrifuge device based on steady-state temperature prediction, comprising:
a working chamber which is provided with a cooling system that acts on a peripheral wall of the working chamber, and a vacuum system that acts on an interior of the working chamber;
a hypergravity centrifuge device which is installed in the working room and has an experimental chamber that rotates around a rotational axis;
a sensor component located within the working chamber and arranged around the hypergravity centrifuge device;
a control system which receives detection signals from the sensor component and controls the cooling system and the vacuum system accordingly according to the temperature control method for a hypergravity centrifuge device according to claim 2.

10. The hypergravity centrifuge device according to claim 9, wherein a height of the sensor component corresponds to a height of the experimental chamber;
the number of sensors in the sensor component is n and divided into multiple groups along a height direction, with sensors in the same group evenly spaced along a circumferential direction.

11. A hypergravity centrifuge device based on steady-state temperature prediction, comprising:
a working chamber which is provided with a cooling system that acts on a peripheral wall of the working chamber, and a vacuum system that acts on an interior of the working chamber;
a hypergravity centrifuge device which is installed in the working room and has an experimental chamber that rotates around a rotational axis;
a sensor component located within the working chamber and arranged around the hypergravity centrifuge device;
a control system which receives detection signals from the sensor component and controls the cooling system and the vacuum system accordingly according to the temperature control method for a hypergravity centrifuge device according to claim 3.

12. The hypergravity centrifuge device according to claim 11, wherein a height of the sensor component corresponds to a height of the experimental chamber;
the number of sensors in the sensor component is n and divided into multiple groups along a height direction, with sensors in the same group evenly spaced along a circumferential direction.

13. A hypergravity centrifuge device based on steady-state temperature prediction, comprising:
a working chamber which is provided with a cooling system that acts on a peripheral wall of the working chamber, and a vacuum system that acts on an interior of the working chamber;
a hypergravity centrifuge device which is installed in the working room and has an experimental chamber that rotates around a rotational axis;
a sensor component located within the working chamber and arranged around the hypergravity centrifuge device;
a control system which receives detection signals from the sensor component and controls the cooling system and the vacuum system accordingly according to the temperature control method for a hypergravity centrifuge device according to claim 4.

14. The hypergravity centrifuge device according to claim 13, wherein a height of the sensor component corresponds to a height of the experimental chamber;
the number of sensors in the sensor component is n and divided into multiple groups along a height direction, with sensors in the same group evenly spaced along a circumferential direction.

15. A hypergravity centrifuge device based on steady-state temperature prediction, comprising:
a working chamber which is provided with a cooling system that acts on a peripheral wall of the working chamber, and a vacuum system that acts on an interior of the working chamber;
a hypergravity centrifuge device which is installed in the working room and has an experimental chamber that rotates around a rotational axis;
a sensor component located within the working chamber and arranged around the hypergravity centrifuge device;
a control system which receives detection signals from the sensor component and controls the cooling system and the vacuum system accordingly according to the temperature control method for a hypergravity centrifuge device according to claim 5.

16. The hypergravity centrifuge device according to claim 15, wherein a height of the sensor component corresponds to a height of the experimental chamber;
the number of sensors in the sensor component is n and divided into multiple groups along a height direction, with sensors in the same group evenly spaced along a circumferential direction.

17. A hypergravity centrifuge device based on steady-state temperature prediction, comprising:
a working chamber which is provided with a cooling system that acts on a peripheral wall of the working chamber, and a vacuum system that acts on an interior of the working chamber;
a hypergravity centrifuge device which is installed in the working room and has an experimental chamber that rotates around a rotational axis;
a sensor component located within the working chamber and arranged around the hypergravity centrifuge device;
a control system which receives detection signals from the sensor component and controls the cooling system and the vacuum system accordingly according to the temperature control method for a hypergravity centrifuge device according to claim 6.

18. The hypergravity centrifuge device according to claim 17, wherein a height of the sensor component corresponds to a height of the experimental chamber;
the number of sensors in the sensor component is n and divided into multiple groups along a height direction, with sensors in the same group evenly spaced along a circumferential direction.
